(19) United States
(12) Patent Application Publication
(10) Pub. No.: US 2007/0021564 A1
(43) Pub. Date: Jan. 25, 2007

(54) Peroxide-cured thermoplastic vulcanizates

(76) Inventors: Maria D. Ellul, Silver Lake Village, OH (US); Paul E. McDaniel, Cuyahoga Falls, OH (US)

Correspondence Address: William G. Muller, 388 South Main Street, Akron, OH, 44311, US

(21) Appl. No.: 11/180,235

(22) Filed: Jul. 13, 2005

(51) Int. Cl. C08F 8/00

(52) U.S. Cl. 525/191

(57) ABSTRACT

A thermoplastic vulcanizate comprising a dynamically-cured rubber, and a thermoplastic resin, where the rubber has been cured with a peroxide in the presence of a coagent selected from the group consisting of a high-vinyl polydiene, high-vinyl polydiene copolymer, α-β-ethylenically unsaturated metal carboxylate, or mixture thereof.

### FIELD OF THE INVENTION

One or more embodiments of this invention relates to peroxide-cured thermoplastic vulcanizates that exhibit technologically useful characteristics that derive, at least in part, from the use of one or more particular cure coagents.

### BACKGROUND OF THE INVENTION

Blends of rubber and plastic have been produced with the hope of making thermoplastic elastomers, which are compositions that exhibit at least some of the properties of thermoset elastomers and yet are processable as thermoplastics. For example, U.S. Pat. No. 3,806,558 teaches blends of monoolefin copolymer rubber and polyolefin resin, where the rubber is partially cured under dynamic conditions. Peroxide curatives may be employed in this process together with auxiliary substances such as sulfur, maleimides including bismaleimides, polyunsaturated compounds (e.g., cyanurate), and acrylic esters (e.g., trimethylolpropanetrimethacrylate). The gel content of the rubber within these blends does not exceed 96%.

In an attempt to improve the optical properties of these compositions, U.S. Pat. No. 4,087,485 teaches dynamically cured blends of polypropylene, low-density polyethylene, and ethylene-propylene copolymer rubber. The dynamic curing process, which at least partially cures the low-density polyethylene and rubber, may be effected with an organic peroxide together with either sulfur and/or certain trifunctional monomers capable of preventing degradation of the polypropylene. These trifunctional monomers include triallyl cyanurate, triallyl phosphate, and tris(2,3-dibromolpropyl)phosphate.

Likewise, attempting to improve upon the permanent set and balance of properties such as tensile strength, weather resistance, oil resistance, and heat stability of these blends, U.S. Pat. No. 4,108,947 teaches dynamically cured blends consisting essentially of an olephinic rubber, a polyolefin resin, and polybutadiene having a 1,2-addition unit content of 70% or more. Partial crosslinking (i.e., less than 96%) is emphasized in order to maintain composition fluidity.

Recognizing fluidity problems, U.S. Pat. No. 4,247,652 teaches blends of a peroxide-curable olefin copolymer rubber (e.g., EPDM), a peroxide-decomposing olefin plastic (e.g., isotactic polypropylene), a peroxide-non-curable hydrocarbon rubbery material (e.g., butyl rubber), and a mineral oil softener. These blends are dynamically cured by employing a peroxide in combination with a peroxy-curing promoter such as sulfur, p-quinone dioxime, p,p′-dibenzoyl quinone dioxime, N-methyl-N,4-dinitrosoaniline, nitrobenzene, diphenyl guanidine, trimethylol propane-N,N′-m-phenylene dimaleimide, or a polyfunctional vinyl monomer such as divinyl benzene or triallyl cyanurate, or a polyfunctional methacrylate monomer such as ethyleneglycol dimethacrylate, diethyleneglycol dimethacrylate, polyethyleneglycol dimethacrylate, trimethylol propane trimethacrylate or allyl methacrylate. Despite the fact that this patent teaches partially-cured rubber, the rubber can purportedly be cured in the range from about 20 to 99% gel content in cyclohexane at 35° C.; although the data set forth in the specification suggests cured levels much lower than 99%.

Similarly, U.S. Pat. No. 4,785,045 teaches dynamically cured blends of a peroxide-crosslinkable olefinic copolymer rubber, a peroxide-crosslinkable polyolefin resin, and a peroxide-decomposable polyolefin resin. The dynamic cure is effected with a peroxide in conjunction with a crosslinking aide such as p-quinonedioxime, p,p′-dibenzoyl quinonedioxime, N-methyl-N,4-dinitrosoaniline, nitrobenzene, diphenyl guanidine, trimethylolpropane-N,N′-m-phenylene dimaleimide, divinylbenzene, triallyl cyanurate, ethylene glycol dimethacrylate, diethylene glycol dimethacrylate, polyethylene glycol dimethacrylate, trimethylolpropane trimethacrylate, allyl methacrylate, vinyl butyrate and vinyl stearate. Despite the fact that this patent teaches partially-cured rubber, the rubber can purportedly be cured in the range from about 45 to about 98% in cyclohexane.

Likewise, attempting to gain a good balance of overall properties, particularly tensile strength and modulus, U.S. Pat. No. 4,948,840, teaches dynamically cured blends of a propylene polymer material, an amorphous ethylene-propylene copolymer rubber, and a semi-crystalline, low-density, essentially linear ethylene-propylene copolymer. The composition is partially cured with a curing system including 1,2-polybutadiene and a peroxide crosslinking agent. In addition to the 1,2-polybutadiene, the cure system may further contain a coagent such as phenylene-bis-maleamide and/or sulfur donors, such as mercaptobenzothiazole, benzothiazyldisulfide, tetramethylthiuram monosulfide, tetramethylthiuram disulfide, dipentamethylenethiuram hexasulfide, N,N′-diethylthiourea, and zinc dibutyldithiocarbamate. The rubber is cured to no more than 94% gel.

Blends of rubber and plastic where the rubber is fully cured are also disclosed. For Example, U.S. Pat. No. 4,130,535 teaches thermoplastic vulcanizates comprising blends of olefin rubber and thermoplastic olefin resin in which the rubber is completely cured (i.e., no more than 3% of the rubber is extractable in cyclohexane at 23° C.). Numerous cure systems are disclosed including those based upon sulfur or peroxides.

Recognizing that the use of peroxides to fully cure thermoplastic vulcanizates can have an undesirable side effect on the plastic, U.S. Pat. No. 6,656,693 teaches the use of elastomeric copolymer rubber deriving from the copolymerization of ethylene, an α-olefin, and 5-vinyl-2-norbornene. When using this particular rubber, peroxide-cured thermoplastic vulcanizates having a high degree of cure could be achieved with the use of less peroxide than had been used in the past. By employing lower levels of peroxide, those physical properties attributable to the plastic phase could be maintained.

Inasmuch as the use of peroxide cure systems to dynamically cure—and ideally fully cure—the rubber phase of thermoplastic vulcanizates offers many advantages, there remains a desire to improve upon the peroxide cure system, particularly with regard to the impact that these systems have on the plastic phase of the thermoplastic vulcanizates.

### SUMMARY OF THE INVENTION

In general the present invention provides a thermoplastic vulcanizate comprising a dynamically-cured rubber, and a thermoplastic resin, where the rubber has been cured with a peroxide in the presence of a coagent selected from the group consisting of a high-vinyl polydiene, high-vinyl polydiene copolymer, α-β-ethylenically unsaturated metal carboxylate, or mixture thereof.

The present invention also includes a method of preparing a thermoplastic vulcanizate, the method comprising dynamically vulcanizing a rubber within a blend including the rubber and a plastic, where said vulcanizing employs a peroxide curative and a coagent selected from the group consisting of a high-vinyl polydiene or high-vinyl polydiene copolymer, a zinc dimethacrylate, or mixture thereof.

### DETAILED DESCRIPTION OF ILLUSTRATIVE EMBODIMENTS

One or more embodiments of this invention are directed toward thermoplastic vulcanizates that are cured with peroxide cure systems that include a high-vinyl polydiene or polydiene copolymer, an α-β-ethylenically unsaturated carboxylic acid salt, or a mixture thereof as a coagent. These coagents have unexpectedly provided for highly-cured thermoplastic vulcanizates demonstrating technologically useful mechanical properties, especially after heat aging. In one or more embodiments, the thermoplastic vulcanizates can be peroxide cured in the presence of additional coagents to provide yet further advantageous properties.

In one or more embodiments, the thermoplastic vulcanizates of this invention include a dynamically-cured rubber and a thermoplastic resin, where the rubber is dynamically cured with a peroxide in the presence of a coagent selected from the group consisting of a high-vinyl polydiene or polydiene copolymer, α-β-ethylenically unsaturated carboxylic acid salt, or mixtures thereof. Other optional ingredients include processing additives, oils, fillers, and other ingredients that are conventionally included in thermoplastic vulcanizates.

Any rubber or mixture thereof that is capable of being dynamically cured with a peroxide cure system may be used. Reference to a rubber may include mixtures of more than one rubber. Non-limiting examples of useful rubbers include olefinic elastomeric copolymers, natural rubber, styrene-butadiene copolymer rubber, butadiene rubber, acrylonitrile rubber, butadiene-styrene-vinyl pyridine rubber, urethane rubber, polyisoprene rubber, epichlorohydrin terpolymer rubber, polychloroprene, and mixtures thereof.

The term olefinic elastomeric copolymer refers to rubbery copolymers polymerized from ethylene, at least one α-olefin monomer, and optionally at least one diene monomer. The α-olefins may include, but are not limited to, propylene, 1-butene, 1-hexene, 4-methyl-1 pentene, 1-octene, 1-decene, or combinations thereof. In one embodiment, the α-olefins include propylene, 1-hexene, 1-octene or combinations thereof. The diene monomers may include, but are not limited to, 5-ethylidene-2-norbornene; 5-vinyl-2-norbornene; divinyl benzene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; or a combination thereof. In the event that the copolymer is prepared from ethylene, α-olefin, and diene monomers, the copolymer may be referred to as a terpolymer or even a tetrapolymer in the event that multiple α-olefins or dienes are used.

In one or more embodiments, the olefinic elastomeric copolymers include from about 12 to about 85% by weight, or from about 20 to about 80% by weight, or from about 40 to about 70% by weight, and or from about 60 to about 66% by weight ethylene units deriving from ethylene monomer, and from about 0.1 to about 15% by weight, or from about 0.5 to about 12% by weight, or from about 1 to about 10% by weight, or from about 2 to about 8% by weight diene units deriving from diene monomer, with the balance including α-olefin units (such as propylene) deriving from α-olefin monomer. Expressed in mole percent, the terpolymer of one embodiment includes from about 0.1 to about 5 mole percent, or from about 0.5 to about 4 mole percent, or from about 1 to about 2.5 mole percent diene units deriving from diene monomer. In one or more embodiments, where the diene includes 5-ethylidene-2-norbornene the olefinic elastomeric copolymer may include at least 6% by weight, in other embodiments at least 8% by weight, and in other embodiments at least 10% by weight units deriving from 5-ethylidene-2-norbornene.

In one or more embodiments, useful olefinic elastomeric copolymers have a weight average molecular weight (M_{w}) that is greater than 50,000, in other embodiments greater than 100,000, in other embodiments greater than 200,000, and in other embodiments greater than 300,000; and the weight average molecular weight of the preferred olefinic elastomeric copolymers of one embodiment is less than 1,200,000, in other embodiments less than 1,000,000, in other embodiments less than 900,000, and in other embodiments less than 800,000. In one or more embodiments, useful olefinic elastomeric copolymers have a number average molecular weight (Mₙ) that is greater than 20,000, in other embodiments greater than 60,000, in other embodiments greater than 100,000, and in other embodiments greater than 150,000; and the number average molecular weight of the olefinic elastomeric copolymers of one or more embodiments is less than 500,000, in other embodiments less than 400,000, in other embodiments less than 300,000, and in other embodiments less than 250,000.

In one or more embodiments, useful olefinic elastomeric copolymers may also be characterized by having a Mooney viscosity (ML₍₁₊₄₎ at 125° C.) per ASTM D 1646, of from about 50 to about 500 or from about 75 to about 450. Where higher molecular weight olefinic elastomeric copolymers are employed within the thermoplastic vulcanizates of this invention, these high molecular weight polymers may be obtained in an oil-extended form. These oil-extended copolymers typically include from about 15 to about 100 parts by weight, per 100 parts by weight rubber, of a paraffinic oil. The Mooney viscosity of these oil-extended copolymers may be from about 45 to about 80 or from about 50 to about 70.

In one or more embodiments, useful olefinic elastomeric copolymers may be characterized by having an inherent viscosity, as measured in Decalin at 135° C., up from about 2 to about 8 dl/g, or from about 3 to about 7 dl/g, or from about 4 to about 6.5 dl/g.

In one embodiment, the elastomeric copolymer is a terpolymer of ethylene, at least one α-olefin monomer, and 5-vinyl-2-norbornene. This terpolymer is advantageous when a peroxide curative is employed as described in U.S. Pat. No. 5,656,693, which is incorporated herein by reference. In one or more embodiments, the terpolymer includes from about 40 to about 90 mole percent of its polymeric units deriving from ethylene, and from about 0.2 to about 5 mole percent of its polymeric units deriving from vinyl norbornene, based on the total moles of the terpolymer, with the balance comprising units deriving from α-olefin monomer. In other embodiments, the elastomeric copolymer includes from about 1 to about 8, and in other embodiments from about 2 to about 5% by weight units deriving from 5-vinyl-2-norbornene. Other useful olefinic elastomeric copolymers are disclosed in U.S. Pat. Nos. 6,268,438, 6,288,171, 6,245,856, and 6,867,260, and U.S Publication No. 2005/010753.

Useful olefinic elastomeric copolymers may be manufactured or synthesized by using a variety of techniques. For example, these copolymers can be synthesized by employing solution, slurry, or gas phase polymerization techniques that employ numerous catalyst systems including Ziegler-Natta systems, single-site catalysts including vanadium catalysts and Group IV-VI metallocenes, and Brookhart catalysts. Elastomeric copolymers are commercially available under the tradenames Vistalon™ (ExxonMobil Chemical Co.; Houston, Tex.), VISTAMAXX™ (ExxonMobil), Keltan™ (DSM Copolymers; Baton Rouge, La.), Nordel™ IP (DuPont Dow Elastomers; Wilmington, Del.), NORDEL MG™ (DuPont Dow Elastomers), Royalene™ (Crompton) and Buna™ (Bayer Corp.; Germany).

In one or more embodiments the rubber can be highly cured. In one embodiment, the rubber is advantageously completely or fully cured. The degree of cure can be measured by determining the amount of rubber that is extractable from the thermoplastic vulcanizate by using cyclohexane or boiling xylene as an extractant. This method is disclosed in U.S. Pat. No. 4,311,628, which is incorporated herein by reference for purpose of U.S. patent practice. In one embodiment, the rubber has a degree of cure where not more than 6 weight percent, in other embodiments not more than 5 weight percent, in other embodiments not more than 3 weight percent, and in other embodiments not more than 2 weight percent is extractable by cyclohexane at 23° C. as described in U.S. Pat. Nos. 5,100,947 and 5,157,081, which are incorporated herein by reference for purpose of U.S. patent practice. Alternatively, in one or more embodiments, the rubber has a degree of cure such that the crosslink density is preferably at least 4×10⁻⁵, in other embodiments at least 7×10⁻⁵, and in other embodiments at least 10×10⁻⁵ moles per milliliter of rubber. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

Useful peroxide curatives include organic peroxides. Examples of organic peroxides include, but are not limited to, di-tert-butyl peroxide, dicumyl peroxide, t-butylcumyl peroxide, α,α-bis(tert-butylperoxy)diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4-bis(tert-butylperoxy)valerate, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals and mixtures thereof may be used. Useful peroxides and their methods of use in dynamic vulcanization of thermoplastic vulcanizates are disclosed in U.S. Pat. No. 5,656,693, which is incorporated herein by reference for purpose of U.S. patent practice.

In one or more embodiments, high-vinyl polydienes or polydiene copolymers include those polymers and copolymers where at least 50%, in other embodiments at least 65%, in other embodiments at least 75%, and in other embodiments at least 85% of the dienyl mer units are in the 1,2 or vinyl microstructure or configuration. The dienyl mer units may derive from the polymerization of conjugated diene such as, but not limited to, 1,3-butadiene. The high-vinyl polydienes may include homopolymers of a particular conjugated diene (e.g., polybutadiene) or copolymers of two or more conjugated dienes. In other embodiments, the high-vinyl polydienes or polydiene copolymers may include non-dienyl units deriving from monomer copolymerizable with conjugated dienes such as vinyl aromatic monomer. For example, the high-vinyl polydiene copolymers may include styrenyl units deriving from copolymerization with styrene monomer.

In one or more embodiments, the high-vinyl polydienes include atactic 1,2-polybutadiene. Atactic 1,2-polybutadiene, or atactic high-vinyl polybutadiene, may include a viscous liquid having a structure in which the side-chain vinyl groups are located randomly. These polymers can be prepared by employing lithium catalyzed polymerization using polar modifiers, such as chelating diamines, oxygenated ether compounds, acetals, and ketals. U.S. Pat. No. 4,696,986, which is incorporated herein by reference, teaches a useful method. The atactic polybutadiene typically may have a number average molecular weight (Mn) ranging from about 1,300 to 130,000. Atactic polybutadiene can be obtained commercially in both liquid and solid supported form.

In other embodiments, the high-vinyl polydienes may include syndiotactic 1,2-polybutadiene. Syndiotactic 1,2-polybutadiene includes a semi-crystalline thermoplastic resin that has a stereoregular structure in which the side-chain vinyl groups are located alternately on the opposite sides in relation to the polymeric main chain. The 1,2-polymerization of the butadiene may occur in a head-to-tail fashion thereby generating a new chiral center. In the syndiotactic polymer, alternate chiral centers can have the same configuration. Syndiotactic 1,2-polybutadiene of one or more embodiments may be characterized by less than about 90% crystallinity.

Syndiotactic 1,2-polybutadiene polymer may be prepared by any suitable means including by solution, emulsion, or suspension polymerization using a Ziegler-type catalyst. A variety of coordination catalyst systems such as cobalt-based systems, iron-based catalyst systems, molybdenum-based catalyst systems, and chromium-based catalyst systems can be used as described in U.S. Pat. No. 6,201,080, which is incorporated herein by reference.

The physical, mechanical, and rheological properties of syndiotactic 1,2-polybutadiene form may be affected by its melting point, vinyl content, and degree of crystallinity. A melting point of 206° C. may be possible, depending on the synthetic method used. In one or more embodiments, the syndiotactic content of the syndiotactic 1,2-polybutadiene can be high enough to provide a crystalline melting point of at least about 60° C., in other embodiments greater than about 70° C., and in these or other embodiments less than about 205° C. The 1,2-vinyl content can be greater than 50%, and in other embodiments greater than 75%. The degree of crystallinity of the syndiotactic polybutadiene may be less than about 50%, and in other embodiments from about 10 to 45%. The weight average molecular weight of syndiotactic 1,2-polybutadiene employed in one or more embodiments may be greater than about 100,000. Advantageously, syndiotactic 1,2-polybutadiene can be easier to handle and can cost less than the atactic high vinyl polybutadiene.

High-vinyl polybutadiene copolymers of 1,3-butadiene and styrene include high-vinyl solution styrene-butadiene elastomers. These copolymers may be formed by the copolymerization of a conjugated diolefin monomer, such as 1,3-butadiene, with a vinyl aromatic monomer, such as styrene. In one or more embodiments, the vinyl content of the high vinyl solution styrene-butadiene elastomer can be greater than about 60%, and in other embodiments greater than about 70%. A solution polymerization process for making high vinyl styrene-butadiene is described in U.S. Pat. No. 6,140,434, which is hereby incorporated herein by reference.

In one or more embodiments, the high-vinyl polydienes or polydiene copolymers can be provided together with a carrier or support. In one or more embodiments, these carriers or supports include solid inert materials. Examples of solid inert materials include silica, various clays, and silicates.

High-vinyl polydienes are commercially available from numerous sources. One example is Ricon™ 154 (Sartomer; Pennsylvania) polybutadiene resin, which is a low molecular weight, liquid polybutadiene resin with very high vinyl functionality. Also, a similar polybutadiene resin can be obtained together with an inert powder carrier under the tradename Ricon™ 154D.

In one or more embodiments, the α-β-ethylenically unsaturated carboxylic acid salts (i.e., α-β-ethylenically unsaturated metal carboxylates) include from 3 to about 8 carbon atoms. Exemplary α-β-ethylenically unsaturated carboxylic acids that can be reacted or interacted with a metallic base to yield the carboxylate include acrylic acid, methacrylic acid, cinnamic acid, and crotonic acid. The metal ions that can be reacted or interacted with the carboxylic acid include sodium, potassium, magnesium, calcium, zinc, barium, aluminum, tin, zirconium, lithium, and cadmium. In one or more embodiments, the α-β-ethylenically unsaturated metal carboxylates include zinc dimethacrylate, zinc diacrylate, or a mixture thereof.

Useful zinc dimethacrylate can be obtained from several commercial sources. One example includes that available under the tradename SR708™ (Sartomer; Pennsylvania). Useful zinc diacrylate can be obtained from several commercial sources. One example includes that available under the tradename SR705™ (Sartomer; Pennsylvania).

In addition to the α-β-ethylenically unsaturated metal carboxylate and/or high-vinyl polydiene or polydiene copolymer, a complementary coagent may be used. These complementary coagents may be selected from the group consisting of triallylcyanurate, triallyl isocyanurate, triallyl phosphate, sulfur, N-phenyl bis-maleamide, divinyl benzene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, and oximers such as quinone dioxime.

Any thermoplastic resin that can be employed in the manufacture of thermoplastic vulcanizates can be used to manufacture the thermoplastic vulcanizates of this invention. Useful thermoplastic resins include solid, generally high molecular weight plastic resins. These resins include crystalline and semi-crystalline polymers including those having a crystallinity of at least 25% as measured by differential scanning calorimetry. Selection of particular resins may include those that have a melt temperature lower than the decomposition temperature of the rubber selected.

In one or more embodiments, useful thermoplastic resins may be characterized by an M_{w} of from about 200,000 to about 2,000,000 and in other embodiments from about 300,000 to about 600,000. They are also characterized by an Mₙ of about 80,000 to about 800,000, and in other embodiments about 90,000 to about 150,000, as measured by GPC with polystyrene standards.

In one or more embodiments, these thermoplastic resins can have a melt flow rate that is less than about 10 dg/min, in other embodiments less than about 2 dg/min, in other embodiments less than about 1.0 dg/min, and in other embodiments less than about 0.5 dg/min, per ASTM D-1238 at 230° C. and 2.16 kg load.

In one ore more embodiments, these thermoplastic resins also can have a melt temperature (Tₘ) that is from about 150° C. to about 250° C., in other embodiments from about 155 to about 170° C., and in other embodiments from about 160° C. to about 165° C. They may have a glass transition temperature (T_{g}) of from about −10 to about 10° C., in other embodiments from about −3 to about 5° C., and in other embodiments from about 0 to about 2° C. In one or more embodiments, they may have a crystallization temperature (T_{c}) of these optionally at least about 75° C., in other embodiments at least about 95° C., in other embodiments at least about 100° C., and in other embodiments at least 105° C., with one embodiment ranging from 105° to 115° C.

Also, these thermoplastic resins may be characterized by having a heat of fusion of at least 25 J/g, in other embodiments in excess of 50 J/g, in other embodiments in excess of 75 J/g, and in other embodiments in excess of 95 J/g.

Exemplary thermoplastic resins include crystalline and crystallizable polyolefins. Also, the thermoplastic resins may include copolymers of polyolefins with styrene such as styrene-ethylene copolymer. In one embodiment, the thermoplastic resins are formed by polymerizing ethylene or α-olefins such as propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene and ethylene and propylene with another α-olefin such as 1-butene, 1-hexene, 1-octene, 2-methyl-1-propene, 3-methyl-1-pentene, 4-methyl-1-pentene, 5-methyl-1-hexene or mixtures thereof is also contemplated. Specifically included are the reactor, impact, and random copolymers of propylene with ethylene or the higher α-olefins, described above, or with C₁₀-C₂₀ diolefins. Comonomer contents for these propylene copolymers will typically be from 1 to about 30% by weight of the polymer, for example, See U.S. Pat. Nos. 6,268,438, 6,288,171, 6,867,260 B2, 6,245,856, and U.S. Publication No. 2005/010753, which are incorporated herein by reference. Copolymers available under the tradename VISTAMAXX™ (ExxonMobil) are specifically included. Blends or mixtures of two or more polyolefin thermoplastics such as described herein, or with other polymeric modifiers, are also suitable in accordance with this invention. These homopolymers and copolymers may be synthesized by using an appropriate polymerization technique known in the art such as, but not limited to, the conventional Ziegler-Natta type polymerizations, and catalysis employing single-site organometallic catalysts including, but not limited to, metallocene catalysts.

In one embodiment, the thermoplastic resin includes a high-crystallinity isotactic or syndiotactic polypropylene. This polypropylene can have a density of from about 0.85 to about 0.91 g/cc, with the largely isotactic polypropylene having a density of from about 0.90 to about 0.91 g/cc. Also, high and ultra-high molecular weight polypropylene that has a fractional melt flow rate can be employed. These polypropylene resins are characterized by a melt flow rate that is less than or equal to 10 dg/min, optionally less than or equal to 1.0 dg/min, and optionally less than or equal to 0.5 dg/min per ASTM D-1238 at 2.16 kg load.

In one embodiment, the thermoplastic resin includes a propylene copolymer deriving from the copolymerization of monomer including i) propylene, ii) an α, internal non-conjugated diene monomer, iii) optionally an α, ω non-conjugated diene monomer, and iv) optionally ethylene, or a propylene copolymer deriving from the copolymerization of monomer including i) propylene, ii) an olefin containing a labile hydrogen, and iii) optionally ethylene. These propylene copolymers are disclosed in U.S. Ser. No. 10/938,369, which is incorporated herein by reference. These propylene copolymers can be used as the sole thermoplastic component, or they may be used in conjunction with other thermoplastic resins including those described herein.

In certain embodiments, the thermoplastic vulcanizate may include a polymeric processing additive. The processing additive may be a polymeric resin that has a very high melt flow index. These polymeric resins include both linear and branched polymers that have a melt flow rate that is greater than about 500 dg/min, more preferably greater than about 750 dg/min, even more preferably greater than about 1000 dg/min, still more preferably greater than about 1200 dg/min, and still more preferably greater than about 1500 dg/min. Mixtures of various branched or various linear polymeric processing additives, as well as mixtures of both linear and branched polymeric processing additives, can be employed. Reference to polymeric processing additives can include both linear and branched additives unless otherwise specified. Linear polymeric processing additives include polypropylene homopolymers, and branched polymeric processing additives include diene-modified polypropylene polymers. Thermoplastic vulcanizates that include similar processing additives are disclosed in U.S. Pat. No. 6,451,915, which is incorporated herein by reference for purpose of U.S. patent practice.

In one or more embodiments, the thermoplastic vulcanizates may include a mineral oil, a synthetic oil, or a combination thereof. These oils may also be referred to as plasticizers or extenders. Mineral oils may include aromatic, naphthenic, paraffinic, and isoparaffinic oils. In one or more embodiments, the mineral oils may be treated or untreated. Useful mineral oils can be obtained under the tradename SUNPAR™ (Sun Chemicals). Others are available under the name PARALUX™ (Chevron).

In one or more embodiments, synthetic oils include polymers and oligomers of butenes including isobutene, 1-butene, 2-butene, butadiene, and mixtures thereof. In one or more embodiments, these oligomers include isobutenyl mer units. Exemplary synthetic oils include polyisobutylene, poly(isobutylene-co-butene), polybutadiene, poly(butadiene-co-butene), and mixtures thereof. In one or more embodiments, synthetic oils may include polylinear α-olefins, polybranched α-olefins, hydrogenated polyalphaolefins, and mixtures thereof.

In one or more embodiments, the synthetic oils include synthetic polymers or copolymers having a viscosity in excess of about 20 cp, in other embodiments in excess of about 100 cp, and in other embodiments in excess of about 190 cp, where the viscosity is measured by a Brookfield viscometer according to ASTM D-4402 at 38° C.; in these or other embodiments, the viscosity of these oils can be less than 4,000 cp and in other embodiments less than 1,000 cp.

In one or more embodiments, these oligomers can be characterized by a number average molecular weight (Mₙ) of from about 300 to about 9,000 g/mole, and in other embodiments from about 700 to about 1,300 g/mole.

Useful synthetic oils can be commercially obtained under the tradenames Polybutene™ (Soltex; Houston, Tex.), Indopol™ (BP; Great Britain), and Parapol™ (ExxonMobil). Oligomeric copolymers deriving from butadiene and its comonomers are commercially available under the tradename Ricon Resin™ (Ricon Resins, Inc; Grand Junction, Colo.). White synthetic oil is available under the tradename SPECTRASYN™ (ExxonMobil), formerly SHF Fluids (Mobil).

In one or more embodiments, the extender oils may include organic esters, alkyl ethers, or combinations thereof including those disclosed in U.S. Pat. Nos. 5,290,866 and 5,397,832, which are incorporated herein by reference. In one or more embodiments, the organic esters and alkyl ether esters may have a molecular weight that is generally less than about 10,000. In one or more embodiments, suitable esters include monomeric and oligomeric materials having an average molecular weight of below about 2,000 and in other embodiments below about 600. in one or more embodiments, the esters may be compatible or miscible with both the polyalphaolefin and rubber components of the composition; i.e., they may mix with other components to form a single phase. In one or more embodiments, the esters include aliphatic mono- or diesters, or alternatively oligomeric aliphatic esters or alkyl ether esters. In one or more embodiments, the thermoplastic vulcanizates are devoid of polymeric aliphatic esters and aromatic esters, as well as phosphate esters.

In addition to the rubber, thermoplastic resins, and optional processing additives, the thermoplastic vulcanizates of the invention may optionally include reinforcing and non-reinforcing fillers, antioxidants, stabilizers, rubber processing oil, lubricants, antiblocking agents, anti-static agents, waxes, foaming agents, pigments, flame retardants and other processing aids known in the rubber compounding art. These additives can comprise up to about 50 weight percent of the total composition. Fillers and extenders that can be utilized include conventional inorganics such as calcium carbonate, clays, silica, talc, titanium dioxide, carbon black and the like.

In one or more embodiments, the thermoplastic vulcanizates of this invention contain a sufficient amount of the rubber to form rubbery compositions of matter. The skilled artisan will understand that rubbery compositions of matter include those that have ultimate elongations greater than 100 percent, and that quickly retract to 150 percent or less of their original length within about 10 minutes after being stretched to 200 percent of their original length and held at 200 percent of their original length for about 10 minutes.

Thus, in one or more embodiments, the thermoplastic vulcanizates can include at least about 25 percent by weight, in other embodiments at least about 45 percent by weight, in other embodiments at least about 65 percent by weight, and in other embodiments at least about 75 percent by weight rubber. In these or other embodiments, the amount of rubber within the thermoplastic vulcanizates can be from about 15 to about 90 percent by weight, in other embodiments from about 45 to about 85 percent by weight, and in other embodiments from about 60 to about 80 percent by weight, based on the entire weight of the rubber and thermoplastic combined.

In one or more embodiments, the amount of thermoplastic resin within the thermoplastic vulcanizates can be from about 15 to about 85% by weight, in other embodiments from about 20 to about 75% by weight, based on the entire weight of the rubber and thermoplastic combined. In these or other embodiments, the thermoplastic vulcanizates can include from about 15 to about 25, and in other embodiments from about 30 to about 60, and in other embodiments from about 75 to about 300 parts by weight thermoplastic resin per 100 parts by weight rubber.

When employed, the thermoplastic vulcanizates may include from about 0 to about 20 parts by weight, or from about 1 to about 10 parts by weight, or from about 2 to about 6 parts by weight of a polymeric processing additive per 100 parts by weight rubber.

Fillers, such as carbon black or clay, may be added in amount from about 10 to about 250, per 100 parts by weight of rubber. The amount of carbon black that can be used depends, at least in part, upon the type of carbon black and the amount of extender oil that is used.

Generally, from about 5 to about 300 parts by weight, or from about 30 to about 250 parts by weight, or from about 70 to about 200 parts by weight, of extender oil per 100 parts rubber can be added. The quantity of extender oil added depends upon the properties desired, with the upper limit depending upon the compatibility of the particular oil and blend ingredients; this limit is exceeded when excessive exuding of extender oil occurs. The amount of extender oil depends, at least in part, upon the type of rubber. High viscosity rubbers are more highly oil extendable. Where ester plasticizers are employed, they are generally used in amounts less than about 250 parts, or less than about 175 parts, per 100 parts rubber.

In one or more embodiments, the rubber is cured or crosslinked by dynamic vulcanization. The term dynamic vulcanization refers to a vulcanization or curing process for a rubber contained in a blend with a thermoplastic resin, wherein the rubber is crosslinked or vulcanized under conditions of high shear at a temperature above the melting point of the thermoplastic.

In one embodiment, the rubber can be simultaneously crosslinked and dispersed as fine particles within the thermoplastic matrix, although other morphologies may also exist. Dynamic vulcanization can be effected by mixing the thermoplastic elastomer components at elevated temperature in conventional mixing equipment such as roll mills, stabilizers, Banbury mixers, Brabender mixers, continuous mixers, mixing extruders and the like. Methods for preparing thermoplastic vulcanizates is described in U.S. Pat. Nos. 4,311,628, 4,594,390, and 6,656,693 which are incorporated herein by reference for purpose of U.S. patent practice, although methods employing low shear rates can also be used. Multiple step processes can also be employed whereby ingredients such as plastics, oils, and scavengers can be added after dynamic vulcanization has been achieved as disclosed in International Application No. PCT/US04/30517, which is incorporated herein by reference for purpose of U.S. patent practice.

The skilled artisan will be able to readily determine a sufficient or effective amount of vulcanizing agent to be employed without undue calculation or experimentation.

In one or more embodiments, where a di-functional peroxide is employed, the peroxide can be employed in an amount from about 1×10⁻⁵ moles to about 1×10⁻¹ moles, optionally from about 1×10⁻⁴ moles to about 9×10⁻² moles, and optionally from about 1×10⁻² moles to about 4×10⁻² moles per 100 parts by weight rubber. Those skilled in the art will be able to readily calculate the number of moles that would be useful for other peroxide based upon this teaching; for example, more peroxide might be useful for monofunctional peroxide compounds, and less peroxide might be useful where peroxides having greater functionality are employed. The amount may also be expressed as a weight per 100 parts by weight rubber. This amount, however, may vary depending on the curative employed. For example, where 4,4-bis(tert-butyl peroxy)diisopropyl benzene is employed, the amount employed may include from about 0.5 to about 12 and optionally from about 1 to about 6 parts by weight per 100 parts by weight rubber.

Where a high-vinyl polydiene or polydiene copolymer is employed as a coagent, useful amounts of polydiene coagent include from about 5 to about 50, and in other embodiments from about 10 to about 25 parts by weight high-vinyl polydiene or polydiene copolymer per 100 parts by weight rubber.

Where α-β-ethylenically unsaturated metal carboxylate is employed as a coagent, useful amounts of α-β-ethylenically unsaturated metal carboxylate include from about 2 to about 30, in other embodiments from about 4 to about 20, and in other embodiments from about 8 to about 10 parts by weight α-β-ethylenically unsaturated metal carboxylate per 100 parts by weight rubber.

Where a complementary coagent is employed, such as triallylcyanurate, useful amounts of triallylcyanurate include from about 2 to about 12, in other embodiments from about 4 to about 10, and in other embodiments from about 6 to about 8 parts by weight complementary coagent per 100 parts by weight rubber. In one or more embodiments, the amount (i.e., either moles or parts by weight) of the coagent can be increased or decreased depending on desired properties.

Despite the fact that the rubber may be partially or fully cured, the compositions of this invention can be processed and reprocessed by conventional plastic processing techniques such as extrusion, injection molding, blow molding, and compression molding. The rubber within these thermoplastic elastomers can be in the form of finely-divided and well-dispersed particles of vulcanized or cured rubber within a continuous thermoplastic phase or matrix. In other embodiments, a co-continuous morphology or a phase inversion can be achieved. In those embodiments where the cured rubber is in the form of finely-divided and well-dispersed particles within the thermoplastic medium, the rubber particles can have an average diameter that is less than 50 μm, optionally less than 30 μm, optionally less than 10 μm, optionally less than 5 μm, and optionally less than 1 μm. In certain embodiments, at least 50%, optionally at least 60%, and optionally at least 75% of the particles have an average diameter of less than 5 μm, optionally less than 2 μm, and optionally less than 1 μm.

The thermoplastic elastomers of this invention are useful for making a variety of articles such as weather seals, hoses, belts, gaskets, moldings, boots, elastic fibers and like articles. They are particularly useful for making articles by blow molding, extrusion, injection molding, thermo-forming, elasto-welding and compression molding techniques. More specifically, they are useful for making vehicle parts such as weather seals, brake parts such as cups, coupling disks, and diaphragm cups, boots for constant velocity joints and rack and pinion joints, tubing, sealing gaskets, parts of hydraulically or pneumatically operated apparatus, o-rings, pistons, valves, valve seats, valve guides, and other elastomeric polymer based parts or elastomeric polymers combined with other materials such as metal/plastic combination materials. Also contemplated are transmission belts including V-belts, toothed belts with truncated ribs containing fabric faced V's, ground short fiber reinforced V's or molded gum with short fiber flocked V's.

In order to demonstrate the practice of the present invention, the following examples have been prepared and tested. The examples should not, however, be viewed as limiting the scope of the invention. The claims will serve to define the invention.

### EXAMPLES

Samples 1-31

Thirty-one thermoplastic vulcanizates were prepared by dynamically vulcanizing an elastomeric copolymer by using a peroxide cure system that included various coagents.

The following ingredients were used in each sample and processed by using the procedures generally set forth in U.S. Pat. Nos. 4,594,390 and 6,656,693, which are incorporated herein by reference. The ingredients included 100 parts by weight of elastomeric copolymer (this amount refers only to the rubber component even though the stock included 100 parts by weight rubber and 100 parts by weight oil), 56 parts by weight thermoplastic polymer, 125 total parts by weight paraffinic oil (125 parts including the 100 parts inclusive with the rubber), 42 parts by weight clay, and 2 part by weight antioxidant, each based on 100 parts by weight of the elastomeric copolymer.

The elastomeric copolymer was poly(ethylene-co-propylene-co-vinyl norbornene) characterized by having a diene content of about 3 weight percent, a Mooney viscosity of about 63 (oil extended), an ethylene content of about 63 weight percent, and an oil content of 100 phr, although as described above, the parts by weight rubber disclosed above simply refers to the amount of rubber even though the rubber stock included an oil. The peroxide was 2,5-dimethyl-2,5-di(t-butylperoxy)hexane obtained under the tradename PAR 100™ (Rhein Chemie); this peroxide was 50% active in paraffinic oil which refers to the fact that the ingredient included 50% by weight of the active peroxide compound and 50% by weight paraffinic oil. The thermoplastic resin was characterized by MFR 0.7 dg/min. The antioxidant was tetrakis(methylene 3,5-ditert-butyl-4 hydroxy hydrocinnamate)methane obtained under the tradename IRGANOX™ 1010 (Ciba Geigy).

With respect to the coagents, the zinc dimethacrylate was SR708 (Sartomer); the zinc diacrylate was obtained under the tradename SR705 (Sartomer); the trimethylol propane trimethacrylate was 75% active on a calcium silicate carrier; the high-vinyl polybutadiene had a molecular weight of 5,200, a vinyl content of 90%; the polybutadiene was obtained under the tradename Ricon™ 154D as a masterbatch that was 65 weight percent additive and included 30 weight percent calcium silicate carrier; the divinyl benzene was obtained form Aldrich; the cyclohexane dimethanol diacrylate was 73% active and included 2% alkylated phenol and 25% by weight calcium silicate carrier; the triallylisocyanurate was a neat liquid; and the N,N′-m-phenylenedimaleimide (HVA-2) WAS 70% active in EPDM binder and was obtained under the tradename Polydispersion™ T MPDM D7055C (Rhein Chemie).

The amount of peroxide curative and the type and amount of coagent employed in each sample is set forth in Table I. Also provided in Table I are the results of various tests that were conducted on the samples following dynamic vulcanization. Also provided in Table I are the results of various tests after heat aging, which took place within an air circulating oven at 150° C. for one week. The amounts provided in Table I, as well as the other tables in this specification, are provided in parts by weight per 100 parts by weight rubber (phr) unless otherwise specified. The thermoplastic vulcanizates that are comparative samples have been designated with the letter “C” and those that are within the invention have been labeled with the letter “I.”

TABLE I
A

| | Sample | | | | | | | | | | |
|---|---|---|---|---|---|---|---|---|---|---|---|
| | 1 | 2 | 3 | 4 | 5 | 6 | 7 | 8 | 9 | 10 | 11 |
| Comparative/Invention | I | I | I | I | I | I | C | C | C | C | C |
| Peroxide | 3.30 | 6.60 | 3.30 | 6.60 | 3.30 | 6.60 | 3.30 | 6.60 | 3.30 | 6.60 | 3.30 |
| Coagent | | | | | | | | | | | |
| Zinc Dimethacrylate | 2.02 | 4.04 | — | — | — | — | — | — | — | — | — |
| Zinc Diacrylate | — | — | — | — | 1.78 | 3.56 | — | — | — | — | — |
| Trimethylol Propane | — | — | — | — | — | — | — | — | 2.24 | 4.48 | — |
| Trimethacrylate | | | | | | | | | | | |
| High-Vinyl Polybutadiene | — | — | 10.00 | 20.00 | — | — | — | — | — | — | — |
| Triallylcyanurate | — | — | — | — | — | — | 3.30 | 6.60 | — | — | — |
| Divinyl Benzene | — | — | — | — | — | — | — | — | — | — | — |
| Cyclohexane Dimethanol | — | — | — | — | — | — | — | — | — | — | 2.63 |
| Diacrylate | | | | | | | | | | | |
| Triallylisocyanurate | — | — | — | — | — | — | — | — | — | — | — |
| HVA--2 | — | — | — | — | — | — | — | — | — | — | — |
| Properties | | | | | | | | | | | |
| Wt. Gain %; 121° | 115 | 94 | 121 | 79 | 89 | 83 | 120 | 89 | 101 | 90 | 91 |
| C. @24 hrs | | | | | | | | | | | |
| Tension Set % | 7.5 | 8.5 | 11.0 | 9.5 | 8.5 | 8.0 | 8.0 | 7.0 | 9.5 | 7.0 | 6.5 |
| Compression Set %, | 48 | 42 +/− 5 | 43 | 30 | 41 | 38 +/− 3 | 41 | 34 | 38 | 39 | 39 |
| 1 wk@100° C. | | | | | | | | | | | |
| LCR Viscosity, Pa s | 90 | 85 | 86 | 96 | 73 | 78 | 87 | 80 | 97 | 88 | 93 |
| @204 C., 12001/s | | | | | | | | | | | |
| Shore A | 63 | 64 | 64 | 70 | 65 | 66 | 61 | 64 | 63 | 66 | 64 |
| Shore A after heat aging | 63 | 69 | 66 | 73 | 67 | 70 | 65 | 68 | 60 | 69 | 69 |
| Points change | 0 | 5 | 2 | 3 | 2 | 4 | 4 | 4 | −3 | 3 | 5 |
| UTS(MPa) | 6.88 | 8.02 | 5.94 | 7.35 | 6.33 | 6.41 | 6.90 | 6.32 | 6.91 | 6.37 | 7.13 |
| UTS (MPa) after heat aging | 6.63 | 7.67 | 3.22 | 6.65 | 5.49 | 6.33 | 1.77 | 1.69 | 2.90 | 1.752 | 1.58 |
| % change | −4 | −4 | −46 | −10 | −13 | −1 | −74 | −73 | −58 | −72 | −78 |
| elongation (%) | 368 | 329 | 359 | 251 | 286 | 234 | 361 | 262 | 365 | 269 | 290 |
| elongation after heat aging | 412 | 351 | 151 | 176 | 227 | 233 | 20 | 32 | 197 | 36 | 4 |
| % change | 12 | 7 | −58 | −30 | −21 | 0 | −95 | −88 | −46 | −87 | −99 |
| M100(MPa) | 3.09 | 3.62 | 2.76 | 4.26 | 3.24 | 3.61 | 3.10 | 3.34 | 3.05 | 3.20 | 3.5 |
| M100 (MPa) after heat aging | 2.78 | 3.42 | 2.69 | 5.10 | 3.45 | 3.70 | — | — | 2.11 | — | — |
| % change | −10 | −5 | −2 | 20 | 6 | 2 | −100 | −100 | −31 | −100 | −100 |

B

| | Sample No. | | | | | | | | | |
|---|---|---|---|---|---|---|---|---|---|---|
| | 12 | 13 | 14 | 15 | 16 | 17 | 18 | 19 | 20 | 21 |
| Comparative/Invention | I | I | I | I | I | I | C | C | C | C |
| Peroxide | 8.08 | 6.60 | 6.60 | 6.60 | 6.60 | 6.60 | 6.60 | 6.60 | 6.60 | 6.60 |
| Coagent | | | | | | | | | | |
| Zinc Dimethacrylate | 8.08 | 12.12 | 8.08 | — | — | — | — | — | — | — |
| Zinc Diacrylate | — | — | — | 7.12 | — | — | — | — | — | — |
| Trimethylol Propane | — | — | — | — | — | — | — | — | — | — |
| Trimethacrylate | | | | | | | | | | |
| High-Vinyl Polybutadiene | — | — | — | — | 10.00 | 20.00 | — | — | — | — |
| Triallylcyanurate | — | — | — | — | — | — | — | — | — | — |
| Divinyl Benzene | — | — | — | — | — | — | — | — | 3.52 | 5.16 |
| Cyclohexane Dimethanol | — | — | — | — | — | — | 10.52 | 5.26 | — | — |
| Diacrylate | | | | | | | | | | |
| Triallylisocyanurate | — | — | — | — | — | — | — | — | — | — |
| HVA--2 | — | — | — | — | — | — | — | — | — | — |
| Properties | | | | | | | | | | |
| Wt. Gain %; 121° | 86 | 81 | 86 | 74 | 98 | 82 | 73 | 81 | 90 | 92 |
| C. @24 hrs | | | | | | | | | | |
| Tension Set % | 9.0 | 8.5 | 9.0 | 8.0 | 8.0 | 8.5 | 8.0 | 7.5 | 9.5 | 12.0 |
| Compression Set %, | 54 | 57 | 51 | 40 | 38 | 34 | 33 | 36 | 38 | 45 |
| 1 wk@100° C. | | | | | | | | | | |
| LCR Viscosity, Pa s | 84 | 90 | 91 | 81 | 91 | 97 | 89 | 56 | 100 | 90 |
| @204 C., 12001/s | | | | | | | | | | |
| Shore A | 68 | 69 | 67 | 67 | 65 | 69 | 68 | 69 | 69 | 72 |
| Shore A after heat aging | 70 | 73 | 72 | 72 | 66 | 73 | 69 | 73 | 71 | 77 |
| Points change | 2 | 4 | 5 | 5 | 1 | 4 | 1 | 4 | 2 | 5 |
| UTS(MPa) | 8.02 | 8.72 | 8.20 | 7.20 | 6.59 | 6.98 | 6.82 | 6.62 | 7.34 | 6.54 |
| UTS (MPa) after heat aging | 7.30 | 8.84 | 7.93 | 6.53 | 3.55 | 5.58 | 2.05 | 5.15 | 2.21 | 2.04 |
| % change | −9 | 1 | −3 | −9 | −46 | −20 | −70 | −22 | −70 | −69 |
| elongation (%) | 301 | 311 | 289 | 193 | 317 | 260 | 175 | 327 | 285 | 263 |
| elongation after heat aging | 291 | 316 | 309 | 192 | 130 | 152 | 25 | 188 | 2 | 1 |
| % change | −4 | 2 | 7 | 0 | −59 | −42 | −86 | −42 | −99 | −100 |
| M100(MPa) | 3.80 | 4.13 | 4.07 | 4.68 | 3.36 | 4.11 | 4.55 | 3.48 | 3.74 | 3.80 |
| M100 (MPa) after heat aging | 3.84 | 4.44 | 3.96 | 4.29 | 3.30 | 4.47 | 0.00 | 3.73 | 0.00 | 0.00 |
| % change | 1 | 8 | −3 | −8 | −2 | 9 | −100 | 7.3 | −100 | −100 |

C

| | Sample No. | | | | | | | | | |
|---|---|---|---|---|---|---|---|---|---|---|
| | 22 | 23 | 24 | 25 | 26 | 27 | 28 | 29 | 30 | 31 |
| Comparative/Invention | C | C | C | C | C | C | C | C | C | C |
| Peroxide | 6.60 | 6.60 | 6.60 | 6.60 | 6.60 | 6.60 | 6.60 | 6.60 | 6.60 | 6.60 |
| Coagent | | | | | | | | | | |
| Zinc Dimethacrylate | — | — | — | — | — | — | — | — | — | — |
| Zinc Diacrylate | — | — | — | — | — | — | — | — | — | — |
| Trimethylol Propane | — | — | — | — | — | — | — | — | — | — |
| Trimethacrylate | | | | | | | | | | |
| High-Vinyl Polybutadiene | — | — | — | — | — | — | — | — | — | — |
| Triallylcyanurate | 13.20 | 6.60 | — | — | — | — | 6.60 | 6.60 | — | — |
| Divinyl Benzene | — | — | — | — | — | — | — | — | — | — |
| Cyclohexane Dimethanol | — | — | 10.52 | 5.26 | — | — | — | — | — | — |
| Diacrylate | | | | | | | | | | |
| Triallylisocyanurate | — | — | — | — | — | — | — | — | 6.60 | 6.60 |
| HVA--2 | — | — | — | — | 3.30 | 6.60 | — | — | — | — |
| Properties | | | | | | | | | | |
| Wt. Gain %; 121° | 79 | 90 | 78 | 83 | 80 | 76 | 96 | 99 | 90 | 91 |
| C. @24 hrs | | | | | | | | | | |
| Tension Set % | 7.5 | 7.5 | 8.5 | 7.5 | 8.0 | 9.0 | 8.0 | 8.0 | 8.0 | 8.0 |
| Compression Set %, | 34 | 39 | 32 | 34 | 33 | 32 | — | — | 31 | — |
| 1 wk@100° C. | | | | | | | | | | |
| LCR Viscosity, Pa s | 79 | 80 | 84 | 79 | 77 | 79 | — | — | 73 | — |
| @204 C., 12001/s | | | | | | | | | | |
| Shore A | 68 | 67 | 68 | 66 | 66 | 67 | 63 | 63 | 64 | 64 |
| Shore A after heat aging | 73 | 75 | 78 | 75 | 74 | 77 | 73 | 71 | 73 | 73 |
| Points change | 5 | 8 | 10 | 9 | 8 | 10 | 10 | 8 | 9 | 9 |
| UTS(MPa) | 6.51 | 6.45 | 6.11 | 6.74 | 6.18 | 6.54 | 6.19 | 6.08 | 6.05 | 6.43 |
| UTS (MPa) after heat aging | 2.00 | 1.99 | 3.67 | 2.21 | 2.03 | 2.13 | 2.01 | 1.79 | 1.90 | 2.06 |
| % change | −69 | −69 | −40 | −67 | −67 | −67 | −68 | −70 | −69 | −68 |
| elongation (%) | 198 | 250 | 183 | 243 | 218 | 192 | 278 | 299 | 274 | 304 |
| elongation after heat aging | 2 | 4 | 0 | 1 | 3 | 1 | 2 | 7 | 2 | 3 |
| % change | −99 | −99 | −100 | −100 | −99 | −99 | −99 | −98 | −99 | −99 |
| M100(MPa) | 4.13 | 3.44 | 4.14 | 3.72 | 3.65 | 4.13 | 3.18 | 2.96 | 3.08 | 2.99 |
| M100 (MPa) after heat aging | 0.00 | 0.00 | 0.00 | 0.00 | 0.00 | 0.00 | 0.00 | 0.00 | 0.00 | 0.00 |
| % change | −100 | −100 | −100 | −100 | −100 | −100 | −100 | −100 | −100 | −100 |

Shore hardness was determined according to ASTM D-2240. Ultimate tensile strength, ultimate elongation, and 100% modulus were determined according to ASTM D-412 at 23° C. by using an Instron testing machine. Weight gain was determined according to ASTM D-471. Tension set and compression set were determined according to ASTM D-142. Specific gravity was determined according to ASTM D 792. LCR capillary viscosity was determined with a Dynisco™ Capillary rheometer at 30:1 L/D at 1200 S⁻¹. The samples were subjected to accelerated heat aging within an air circulating oven at 150° C. for one week. Weight gain was determined according to ASTM D471.

The data in Table I shows some of the unexpected results obtained with practicing present invention. In particular, increasing the level of coagent did not have a deleterious impact on tensile strength of the thermoplastic vulcanizates prepared according to the present invention; in fact, tensile strength showed an improvement when the level of coagent was increased. For example, tensile strength increased from 6.88 to 8.02 MPa for Samples 1 and 2. Similar results were obtained between Samples 3 and 4, as well as Samples 5 and 6. This is highly advantageous inasmuch as the use of higher levels of coagent can be employed to achieve lower compression set, which is desirable. The use of commonly employed coagents, such as triallylcyanurate, showed the opposite effect. That is, as shown in Samples 7 and 8, an increase in the level of coagent reduced the ultimate tensile strength. Similar results were obtained with cyclohexane dimethanol diacrylate in Samples 24 and 25.

Moreover, use of the coagents in accord with the present invention showed unexpected results in mechanical properties after heat aging. The samples provided in Table I were intentionally only lightly stabilized with antioxidant so as to determine whether the choice of coagent could provide a more stable composition without the use of excessive antioxidant. In general, the selection of coagents according to the present invention generally showed tolerable changes in mechanical properties after heat aging, whereas several of the compositions that employed comparative coagents showed rather deleterious change in mechanical properties.

Samples 32-37

Six additional thermoplastic vulcanizates were prepared in a similar fashion to Samples 1-32, except that mixtures of coagents were employed. The type and amount of the coagent, as well as the characteristics of the thermoplastic vulcanizate, are set forth in Table II.

TABLE II

| | Sample No. | | | | | |
|---|---|---|---|---|---|---|
| | 32 | 33 | 34 | 35 | 36 | 37 |
| Comparative/Invention | I | I | I | I | I | I |
| Peroxide | 6.60 | 6.60 | 6.60 | 6.60 | 6.60 | 6.60 |
| Coagent | | | | | | |
| Zinc Dimethacrylate | 2.02 | 2.02 | 2.02 | 4.04 | 4.04 | |
| Zinc Diacrylate | — | — | — | — | — | 1.78 |
| Trimethylol Propane Trimethacrylate | — | — | 2.24 | — | — | — |
| High-Vinyl Polybutadiene | — | 10.00 | — | 10.00 | 20.00 | — |
| Triallylcyanurate | 3.30 | — | — | — | — | 3.30 |
| Properties | | | | | | |
| Wt. Gain %; 121° C.@24 hrs | 96 | 94 | 103 | 84 | 78 | 87 |
| Tension Set % | 8.0 | 8.5 | 8.5 | 9 | 9 | 8.5 |
| Compression Set %, 1 wk@100 C. | 38 | 38 | 41 | 40 | 36 | 34 |
| LCR Viscosity, Pa s @204 C., 12001/s | 79 | 88 | 87 | 81 | 94.0 | 83 |
| Shore A | 65 | 69 | 64 | 68 | 71 | 66 |
| Shore A after heat aging | 69 | 71 | 68 | 71 | 74 | 71 |
| Points change | 4 | 2 | 4 | 3 | 3 | 5 |
| UTS (MPa) | 6.61 | 7.40 | 6.88 | 7.23 | 7.44 | 6.73 |
| UTS (MPa) after heat aging | 5.62 | 7.30 | 6.68 | 6.83 | 7.30 | 6.82 |
| % change | −15 | −1 | −3 | −6 | −2 | 1 |
| elongation (%) | 280 | 273 | 344 | 253 | 199 | 235 |
| elongation after heat aging | 228 | 279 | 337 | 245 | 194 | 257 |
| % change | −19 | 2 | −2 | −3 | −3 | 10 |
| M100 (MPa) | 6.61 | 3.83 | 3.10 | 3.92 | 4.76 | 3.72 |
| M100 (MPa) after heat aging | 5.62 | 4.00 | 3.22 | 4.02 | 4.96 | 3.72 |
| % change | −15 | 4 | 4 | 2 | 4 | 0 |

The data in Table II shows the combination of the combination of zinc dimethacrylate or zinc diacrylate in combination with complementary coagents leads to thermoplastic vulcanizates that are relatively stable after heat aging; this is in sharp contrast to the comparative samples set forth in Table I, which degraded after heat aging.

Samples 38-45

Eight additional thermoplastic vulcanizates were prepared in a similar fashion to the preceding samples, except that a different rubber was employed. Namely, the rubber was poly(ethylene-co-propylene-co-ethylidene-2-norbornene) characterized by having a diene content of about 9 weight percent, a Mooney viscosity of about 78 (oil extended), an ethylene content of about 63 weight percent, and an oil content of 100 phr, although as described above, the parts by weight rubber disclosed above simply refers to the amount of rubber even though the rubber stock included an oil The type and amount of the coagent, as well as the characteristics of the thermoplastic vulcanizate, are set forth in Table III.

TABLE III

| | Sample | | | | | | | |
|---|---|---|---|---|---|---|---|---|
| | 38 | 39 | 40 | 41 | 42 | 43 | 44 | 45 |
| Comparative/Invention | I | I | I | I | I | I | C | C |
| Peroxide | 3.30 | 6.60 | 3.30 | 6.60 | 3.30 | 6.60 | 3.30 | 6.60 |
| Coagent | | | | | | | | |
| Zinc Dimethacrylate | 2.02 | 4.04 | — | — | — | — | — | — |
| Zinc Diacrylate | — | — | — | — | 1.78 | 3.56 | — | — |
| High-Vinyl Polybutadiene | — | — | 10.00 | 20.00 | — | — | — | — |
| Triallylcyanurate | — | — | — | — | — | — | 3.30 | 6.60 |
| Properties | | | | | | | | |
| Shore A Hardness | 69 | 70 | 69 | 72 | 65 | 67 | 68 | 69 |
| Wt. Gain %; 121° C.@24 hrs | 133 | 99 | 96 | 67 | 128 | 91 | 107 | 81 |
| Tension Set % | 11.0 | 8.5 | 12.5 | 9.5 | 10.0 | 9.0 | 9.0 | 8.0 |
| Compression Set %, 1 wk@100° C. | 56 | 49 | 44 | 38 | 57 | 47 | 48 | 38 |
| LCR Viscosity, Pa s @204 C., 12001/s | 82 | 75 | 72 | 71 | 91 | 61 | 72 | 58 |
| Shore A | 69 | 70 | 69 | 72 | 65 | 67 | 68 | 69 |
| Shore A after heat aging | 73 | 74 | 71 | 77 | 70 | 73 | 72 | 73 |
| Points change | 4 | 4 | 2 | 5 | 5 | 6 | 4 | 4 |
| UTS (MPa) | 6.54 | 8.59 | 7.27 | 7.19 | 5.36 | 8.12 | 6.32 | 5.39 |
| UTS (MPa) after heat aging | 8.90 | 8.63 | 8.61 | 7.75 | 8.62 | 6.36 | 4.41 | 3.05 |
| % change | 36.2 | 0.5 | 18.4 | 7.7 | 60.9 | −21.6 | −30.1 | −43.4 |
| elongation (%) | 496 | 513 | 478 | 256 | 354 | 447 | 420 | 254 |
| elongation after heat aging | 605 | 472 | 420 | 202 | 539 | 288 | 200 | 83 |
| % change | 22.2 | −8.0 | −12.2 | −21.1 | 52.3 | −35.6 | −52.4 | −67.2 |
| M100 (MPa) | 3.07 | 3.32 | 3.39 | 4.31 | 3.03 | 3.40 | 3.16 | 3.41 |
| M100 (MPa) after heat aging | 3.32 | 3.84 | 4.06 | 5.34 | 3.36 | 3.81 | 2.38 | 2.51 |
| % change | 8.0 | 15.7 | 19.8 | 24.1 | 10.8 | 12.2 | −24.7 | −26.3 |

In consistent fashion with the data of Table I, the data in Table III shows that by selecting coagents in accordance with the present invention, advantageous thermoplastic vulcanizates can be prepared. In particular, thermoplastic vulcanizates characterized by relatively low compression set can be prepared without a deleterious impact on mechanical properties. In fact, the use of zinc dimethacrylate or zinc diacrylate actually led to an increase in tensile strength as the loading of coagent increased. Also, tolerable changes in mechanical properties after heat aging were observed, which was in contradistinction to some of the commonly employed coagents.

Samples 46-54

Nine additional thermoplastic vulcanizates were prepared in a similar fashion to the preceding samples, except that a different rubber was employed. Namely, the rubber was poly(ethylene-co-propylene-co-ethylidene-2-norbornene) characterized by having a diene content of about 4 weight percent, a Mooney viscosity of about 55 (oil extended), an ethylene content of about 64 weight percent, and an oil content of 75 phr, although as described above, the parts by weight rubber disclosed above simply refers to the amount of rubber even though the rubber stock included an oil The type and amount of the coagent, as well as the characteristics of the thermoplastic vulcanizate, are set forth in Table IV.

TABLE IV

| | Sample | | | | | | | | |
|---|---|---|---|---|---|---|---|---|---|
| | 46 | 47 | 48 | 49 | 50 | 51 | 52 | 53 | 54 |
| Comparative/Invention | I | I | I | I | I | I | C | C | C |
| Peroxide | 3.30 | 6.60 | 3.30 | 6.60 | 3.30 | 6.60 | 6.60 | 3.30 | 6.60 |
| Coagent | | | | | | | | | |
| Zinc Dimethacrylate | 2.02 | 4.04 | — | — | — | — | — | — | — |
| Zinc Diacrylate | — | — | — | — | 1.78 | 3.56 | — | — | — |
| Trimethylol Propane | — | — | — | — | — | — | — | 2.24 | 4.48 |
| Trimethacrylate | | | | | | | | | |
| High-Vinyl Polybutadiene | — | — | 10.00 | 20.00 | — | — | — | — | — |
| Triallylcyanurate | — | — | — | — | — | — | 6.60 | — | — |
| Properties | | | | | | | | | |
| Hardness; leverload, Sh.A | 63 | 63 | 63 | 67 | 64 | 65 | 64 | 64 | 65 |
| Wt. Gain %; 121° C.@24 hrs | 163 | 140 | 134 | 85 | 172 | 136 | 101 | 131 | 104 |
| Tension Set % | 10.0 | 10.0 | 10.0 | 8.5 | 12.5 | 10.0 | 8.0 | 11.0 | 8.0 |
| Compression Set %, 168 hrs@100° C. | 68 | 67 | 51 | 38 | 67 | 57 | 43 | 49 | 41 |
| LCR Viscosity, Pa s @204 C., 12001/s | 68.9 | 62.7 | 78.3 | 76.4 | 68.2 | 62.1 | 65.6 | 78.6 | 75.2 |
| Shore A | 63 | 63 | 63 | 67 | 64 | 65 | 64 | 64 | 65 |
| Shore A after heat aging | 64 | 67 | 67 | 71 | 66 | 66 | 62 | 58 | 63 |
| Points change | 1 | 4 | 4 | 4 | 2 | 1 | −2 | −6 | −2 |
| UTS (MPa) | 4.31 | 4.93 | 4.60 | 5.68 | 4.42 | 4.68 | 5.16 | 5.38 | 5.48 |
| UTS (MPa) after heat aging | 3.45 | 4.63 | 4.70 | 6.69 | 5.26 | 3.45 | 2.13 | 1.86 | 1.40 |
| % change | −19.9 | −6.0 | 2.2 | 17.9 | 18.8 | −26.3 | −58.7 | −65.4 | −74.4 |
| elongation (%) | 314 | 327 | 320 | 285 | 371 | 300 | 309 | 394 | 333 |
| elongation after heat aging | 222 | 325 | 255 | 272 | 411 | 179 | 98 | 103 | 37 |
| % change | −29.3 | −0.7 | −20.1 | −4.7 | 10.7 | −40.4 | −68.4 | −73.8 | −88.8 |
| M100 (MPa) | 2.47 | 2.80 | 2.72 | 3.52 | 2.46 | 2.79 | 2.87 | 2.74 | 2.79 |
| M100 (MPa) after heat aging | 2.62 | 2.87 | 3.04 | 4.14 | 2.73 | 2.84 | 2.37 | 1.79 | 0.00 |
| % change | 6.0 | 2.6 | 11.5 | 17.5 | 11.1 | 1.9 | −17.4 | −34.5 | −100.0 |

As with the previous data tables, Table IV demonstrates some of the unexpected findings with respect to practicing the present invention. In particular, the use of increased coagent levels not only led to reduced compression set, which would have been expected, but lead to an increase in tensile properties. This combined with relatively stable heat aged properties is indicative of thermoplastic vulcanizates that are advantageous in view of those prepared using commonly employed coagents.

Various modifications and alterations that do not depart from the scope and spirit of this invention will become apparent to those skilled in the art. This invention is not to be duly limited to the illustrative embodiments set forth herein.

What is claimed is:

1. A thermoplastic vulcanizate comprising:
a dynamically-cured rubber; and
a thermoplastic resin, where the rubber has been cured with a peroxide in the presence of a coagent selected from the group consisting of a high-vinyl polydiene, high-vinyl polydiene copolymer, α-β-ethylenically unsaturated metal carboxylate, or mixture thereof.

2. The thermoplastic vulcanizate of claim 1, where the rubber has been cured with a peroxide in the presence of a complementary coagent.

3. The thermoplastic vulcanizate of claim 3, where the complementary coagent is triallylcyanurate.

4. The thermoplastic vulcanizate of claim 2, where the complementary coagent is trimethylolpropanetrimethacrylate.

5. The thermoplastic vulcanizate of claim 1, where the rubber includes an olefinic elastomeric copolymer deriving from the polymerization of ethylene, at least one α-olefin monomer, and at least one diene monomer.

6. The thermoplastic vulcanizate of claim 5, where the diene includes 5-vinyl-2-norbornene, and where the copolymer includes from about 2 to about 5 weight percent of said 5-vinyl-2-norbornene.

7. The thermoplastic vulcanizate of claim 5, where the at least one diene monomer includes 5-ethylidene-2-norbornene, and the copolymer includes at least about 8% by weight of the 5-ethylidene-2-norbornene.

8. The thermoplastic vulcanizate of claim 1, where the thermoplastic resin includes a propylene copolymer selected from the group of propylene copolymers consisting of those deriving from the polymerization of i) propylene, an α, internal non-conjugated diene monomer, optionally an α,ω non-conjugated diene monomer, and optionally ethylene, and those deriving from the polymerization of ii) a propylene, an olefin containing a labile hydrogen, and optionally ethylene.

9. The thermoplastic vulcanizate of claim 1, where the high-vinyl polydiene includes high-vinyl polybutadiene.

10. The thermoplastic vulcanizate of claim 9, where the rubber has been cured in the presence of from about 5 to about 50 parts by weight high-vinyl polybutadiene per 100 parts by weight rubber.

11. The thermoplastic vulcanizate of claim 11, where the α-β-ethylenically unsaturated metal carboxylate includes zinc diacrylate, zinc dimethacrylate, or a mixture thereof.

12. The thermoplastic vulcanizate of claim 1, where the rubber has been cured in the presence of from about 2 to about 30 parts by weight zinc diacrylate, zinc dimethacrylate or a mixture thereof, per 100 parts by weight rubber.

13. The thermoplastic vulcanizate of claim 1, where the dynamically-cured rubber is cured to an extent where less than 6 weight percent rubber is extractable by cyclohexane at 23° C.

14. The thermoplastic vulcanizate of claim 13, where the dynamically-cured rubber is cured to an extent where less than 5 weight percent rubber is extractable by cyclohexane at 23° C.

15. A method of preparing a thermoplastic vulcanizate, the method comprising:
dynamically vulcanizing a rubber within a blend including the rubber and a plastic, where said vulcanizing employs a peroxide curative and a coagent selected from the group consisting of a high-vinyl polydiene or high-vinyl polydiene copolymer, a zinc dimethacrylate, or mixture thereof.
